(19) United States
(12) Patent Application Publication
(10) Pub. No.: US 2025/0124747 A1
(43) Pub. Date: Apr. 17, 2025

(54) SYSTEMS AND METHODS OF TRACKING FARM VEHICLE PERFORMANCE

(71) Applicant: IntelliCulture Inc., Mississauga (CA)

(72) Inventors: Patrick DiGioacchino, Mississauga (CA); Ramin Shaikhi, Mississauga (CA); Cole Powers, Mississauga (CA); Wenhao Wu, Mississauga (CA); David Hernandez, Mississauga (CA); Urban Pistek, Mississauga (CA)

(73) Assignee: IntelliCulture Inc., Mississauga, ON (CA)

(21) Appl. No.: 18/689,677

(22) PCT Filed: Sep. 13, 2022
(86) PCT No.: PCT/IB2022/058625

§ 371 Date: Mar. 6, 2024

Related U.S. Application Data
(60) Provisional application No. 63/244,114, filed on Sep. 14, 2021.

(51) Int. Cl. G07C 5/02; A01B 76/00; G07C 5/00

(52) U.S. Cl. CPC G07C 5/02; A01B 76/00; G07C 5/008

(57) ABSTRACT

Tracking farm vehicle performance is provided. A system receives a data file comprising geospatial coordinates for a geographic area. The system identifies rows in the geographic area to associate with the geospatial coordinates. The system receives, from a sensor of a vehicle located in the geographic area, a first location point. The system determines, based on a comparison of the first location point and the geospatial coordinates associated with the rows, scores corresponding to a likelihood that the first location point is in each of the rows. The system provides an indication that the vehicle performed an activity on at least a portion of a first row of in the geographic area based on the scores.

### CROSS-REFERENCES TO RELATED APPLICATIONS

This application claims the benefit of priority under 35 U.S.C. § 119 to U.S. Provisional Patent Application No. 63/244,114, filed Sep. 14, 2021, which is hereby incorporated by reference herein in its entirety for all purposes.

### BACKGROUND

Agricultural farms can use farm equipment to facilitate growing various types of crops. For example, a farm can use a tractor or other gas-powered and/or electric vehicle to spray the crops or perform other tasks on the farm. However, as farms become larger or become consolidated with other farms, and farming tasks become more complicated or numerous, it can be challenging to accurately and efficiently track a vehicle's performance of a task on the farm.

### SUMMARY

One technical solution is directed to systems and methods for tracking the performance of a task by farm vehicles or other farm equipment. For example, a farm can include a geographic area with a boundary. The farm can grow one or more types of crops that are separated by rows. The rows can separate the crops that are growing in the farm and provide a path for farm equipment to travel or traverse the farm in order to perform a task on the farm, such as spraying the crops. However, due to imprecise location sensors, such as Global Positioning System sensors or devices, or the lack of reliable network transmission of location data points from the farm equipment to the data processing system, location data received from farm equipment can be noisy, missing, or inaccurate, thereby making it can be challenging to accurately and reliably determine which row in the farm the vehicle is traversing, or which rows the vehicle has traversed or otherwise performed an activity on. For example, in some cases, the location sensor of the vehicle can transmit a first location data point from a first row, and then miss transmitting one or more subsequent data points for the row or the data processing system may not receive the subsequent location data points. Thereafter, the vehicle can enter a second or third row and transmit a location data point, in which case a data processing system may erroneously determine that the vehicle took a diagonal path cutting across rows.

Thus, systems and methods of this technical solution can include a data processing system configured to snap the location data points to predetermined or pre-identified rows in a shapefile for the farm. To do so, the data processing system can process a data file, such as a shapefile, for a farm containing geospatial coordinates and boundaries of the farm. The data processing system can identify one or more blocks in the farm, and one or more rows within the blocks. Thereafter, when the data processing system receive location data points, the data processing system can determine a probability or confidence score that the location data point corresponds to a particular row, thereby snapping the location data point to a particular row. The data processing system can be configured with heuristics, logic, or policies to determine that the vehicle performs an activity on at least a portion of a row (e.g., traverses a row) and is then likely to go to an adjacent row via an end of the row, as opposed to via the middle of a row.

At least one aspect of this technical solution is directed to a system to track farm vehicle performance. The system can include a data processing system comprising one or more processors coupled to memory. The data processing system can receive a data file comprising geospatial coordinates for a geographic area. The data processing system can identify a plurality of rows in the geographic area to associate with the geospatial coordinates. The data processing system can receive, from a sensor of a vehicle located in the geographic area, a first location point. The data processing system can determine, based on a comparison of the first location point and the geospatial coordinates associated with the plurality of rows, a plurality of scores corresponding to a likelihood that the first location point is in each of the plurality of rows. The data processing system can provide an indication that the vehicle performed an activity on at least a portion of a first row of the plurality of rows in the geographic area based on the plurality of scores.

At least one aspect of this technical solution is directed to method of tracking farm vehicle performance. The method can be performed by a data processing system. The method can include the data processing system receiving a data file comprising geospatial coordinates for a geographic area. The method can include the data processing system identifying a plurality of rows in the geographic area to associate with the geospatial coordinates. The method can include the data processing system receiving, from a sensor of a vehicle located in the geographic area, a first location point. The method can include the data processing system determining, based on a comparison of the first location point and the geospatial coordinates associated with the plurality of rows, a plurality of scores corresponding to a likelihood that the first location point is in each of the plurality of rows. The method can include the data processing system providing an indication that the vehicle performed an activity on at least a portion of a first row of the plurality of rows in the geographic area based on the plurality of scores.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system to track farm vehicle performance, in accordance with implementations.

FIG. 2 is an illustration of an example method for tracking farm vehicle performance, in accordance with implementations.

FIG. 3 is an illustration of an example system architecture for tracking farm vehicle performance, in accordance with implementations.

FIG. 4 is an illustration depicting identifying rows on a farm, in accordance with implementations.

FIG. 5 is an illustration depicting a plot of location points received from a vehicle, in accordance with implementations.

FIG. 6 is an illustration depicting a plot snapping the location points of FIG. 5 to the rows of FIG. 4, in accordance with implementations.

FIG. 7 is an illustration of a graphical user interface for interacting with row snapped data, in accordance with implementations.

FIG. 8 is an illustration of tracking performance of one or more vehicles using the system of FIG. 1 or FIG. 3, in accordance with implementations.

FIG. 9 is an illustration of tracking performance of one or more vehicles using the system of FIG. 1 or FIG. 3, in accordance with implementations.

FIGS. 10A-10B are illustrations of providing alerts for one or more vehicles using the system of FIG. 1 or FIG. 3, in accordance with implementations.

FIG. 11 is an illustration of tracking performance of one or more vehicles using the system of FIG. 1 or FIG. 3, in accordance with implementations.

FIG. 12 is an illustration of tracking performance of one or more vehicles using the system of FIG. 1 or FIG. 3, in accordance with implementations.

FIG. 13 is an illustration of tracking performance of one or more vehicles using the system of FIG. 1 or FIG. 3, in accordance with implementations.

FIG. 14 is a block diagram illustrating an architecture for a computer system that can be employed to implement elements of the systems and methods described and illustrated herein, including, for example, the system depicted in FIG. 1 and the method depicted in FIG. 2.

### DETAILED DESCRIPTION

Following below are more detailed descriptions of various concepts related to, and implementations of, methods, apparatuses, and systems of tracking farm vehicle performance. The various concepts introduced above and discussed in greater detail below may be implemented in any of numerous ways.

One technical solution is generally directed to systems and methods of tracking farm vehicle performance. For example, it can be challenging to maintain or manage a farm in a profitable manner due to factors such as rising operation costs, fuel prices and wages that, when compounded with increased global competition, can cause a strain on the agriculture industry. Among these, equipment and vehicles are critical to farm operations and contribute significantly to costs. As farms are consolidating, it can be challenging to accurately, efficiently, and reliable manage farm equipment using information technology. Indeed, in high-value crops (such as fixed tree orchards, cherries or grapes), operations lack visibility into their fleet, resulting in wasted or excessive resource utilization, including delays, latency, wasted energy consumption, fuel, electricity, or spoiled crops. Furthermore, due to the increasingly large number of farm vehicles and equipment that are operating on farms or on consolidated farms, it can be challenging to efficiently monitor all the equipment due to the expensive or excessive hardware requirements for monitoring a full fleet.

Systems and methods of this technical solution can provide farmers with the tools to monitor their equipment and monitor or track the performance of tasks on the farm. A data processing system of this technical solution can include a data logger that can plug into a farm equipment's automotive auxiliary power outlet/OBD II diagnostics connector/J1939 connectors. Through this device, the data processing system can receive, via cellular connection, the collected data to be processed by the data processing system. The data processing system can use the processed data to provide the ability to view and interact with: (i) real-time equipment GPS location updates, (ii) historical analytics on aggregate fleet statistics, (iii) long term forecasting, and (iv) diagnostic records. The data processing system can make this information accessible through a web-based platform or a mobile application platform, for example.

The platform can include one or more views, graphical user interfaces, or portals. For example, a first view can provide a portal and reporting feature that can automate maintenance planning and alerts of machine issues, minimizing operations costs & preventing downtime in the fleet. The platform can provide weekly briefings that provide clarity into fleet health, with remediation to improve output, and minimize depreciation and wear and tear on the machines.

The platform can provide a second view that can automate task planning and alerts of overdue work on the farm, facilitating compliance on the farm while protecting yields. This second view can minimize the time spent coordinating the operation and allows for the timely completion of tasks. In addition, the platform can provide quick summaries via email of what work was done, and by what vehicles, giving insight into which jobs are ongoing and which need manager intervention.

The platform can provide a third view that includes an application configured to facilitate proper spray coverage and provide real time feedback on mis-spray events, reducing spray wastage while improving crop yields. The platform can provide instant or real-time notifications of on field mistakes such as missing a row or spraying where has been sprayed before.

The data processing system of this technical solution can monitor farm equipment and operations to identify and notify farms of errors. The data processing system can prevent mis-spraying events through seamless and efficient alerts, alarms, or reports that provide an indication of what fields have been sprayed. The data processing system can automate maintenance procedures for farms using the data obtained by the data logger plugged into the farm equipment. By tracking maintenance, the data processing system can provide notifications for preventative maintenance of farm equipment, thereby improving the longevity of the farm equipment or preventing more significant failures of the farm equipment, thereby reducing downtime.

Thus, the data processing system of this technical solution can provide holistic farm management capabilities. The data processing system can provide an OEM agnostic solution that allows growers to bring multiple types of machinery into one management platform. The data processing system, being OEM agnostic, can integrate both fleet and operations planning (maintenance, coverage mapping).

To do so, the data processing system of this technical solution is configured with a map-matching functionality designed, constructed and operational for farming applications that allows for cleaning and augmenting noisy GPS data to make the data usable on orchards. The data processing system can receive a shapefile for a farm, and identify rows in between the crops using by the farm vehicle to traverse the farm. The data processing system can receive location data points from a location sensor device on the farm vehicle, and then snap the location data point to geospatial coordinates associated with the identified rows. Once snapped, the data processing system can determine which row or block of the farm the vehicle has traverses, thereby resolving location discrepancies that may arise from low resolution or cheap location sensors or missing location data points.

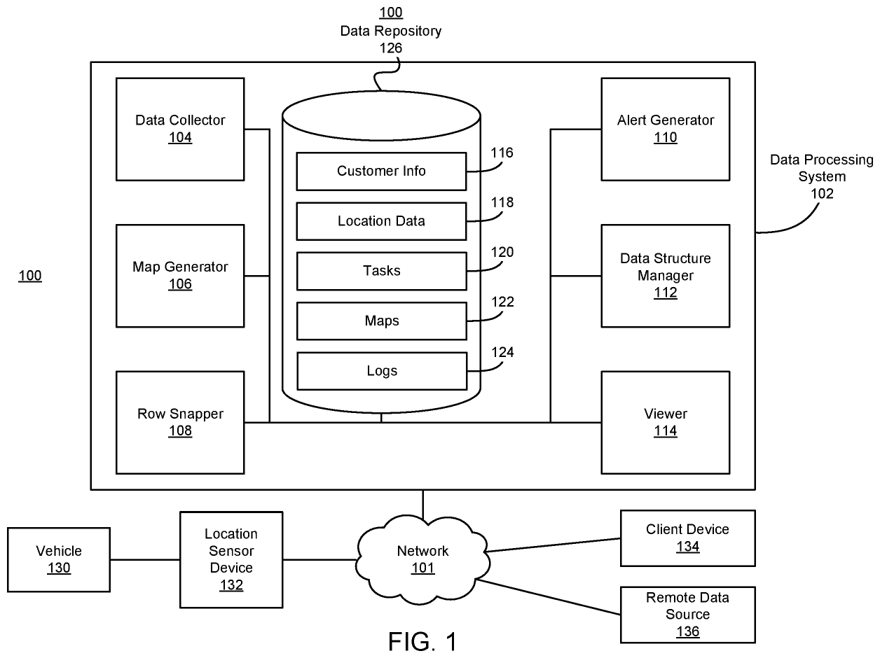

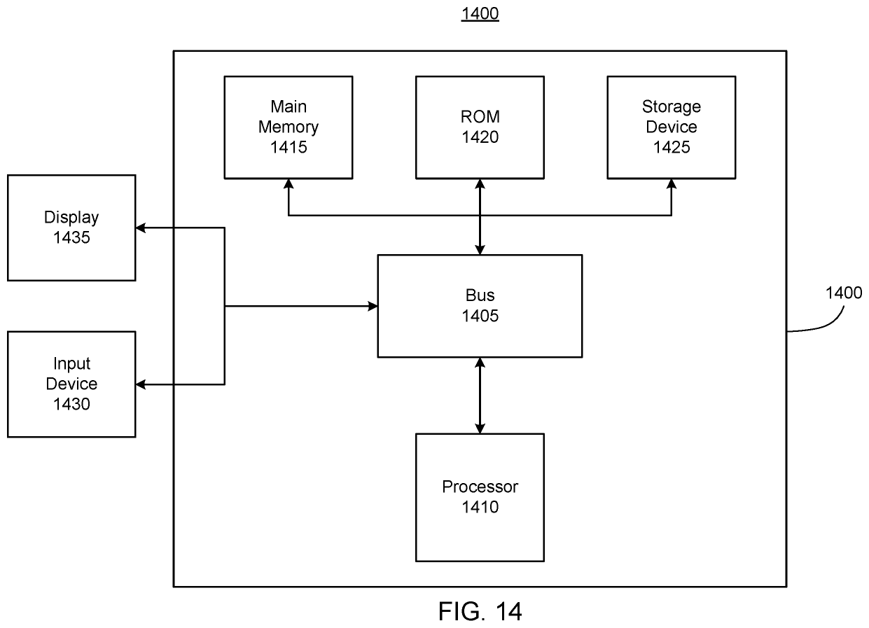

FIG. 1 illustrates an example system 100 of tracking farm vehicle performance. The system 100 can include a data processing system 102. The data processing system 102 can communicate with one or more of a client device 134, location sensor device 132 or vehicle 130 via a network 101. The network 101 can include computer networks such as the Internet, local, wide, metro, or other area networks, intranets, satellite networks, and other communication networks such as voice or data mobile telephone networks. The network 101 can be used to transmit or receive information from various information resources, such as web pages, web-based applications, software-as-a-service applications, or servers that can be provided, output, rendered or displayed on at least one client device 134. The client device 134 can include, for example, a desktop computer, laptop computer, tablet computer, smart phone, mobile telecommunication device, or portable computer. The client device 134 or location sensor device 132 can include one or more component depicted in FIG. 14.

The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 may include a wireless link, such as an infrared channel or satellite band. The topology of the network 101 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The system 100 can include at least one data processing system 102. The data processing system 102 can include at least one logic device such as a computing device having a processor to communicate via the network 101, for example with the client device 134 or location sensor device 132. The data processing system 102 can include at least one computation resource, server, processor or memory. For example, the data processing system 102 can include a plurality of computation resources or servers located in at least one data center. The data processing system 102 can be part of or include a cloud computing environment. The data processing system 102 can include multiple, logically-grouped servers and facilitate distributed computing techniques. The logical group of servers may be referred to as a data center, server farm or a machine farm. The servers can also be geographically dispersed. A data center or machine farm may be administered as a single entity, or the machine farm can include a plurality of machine farms. The servers within each machine farm can be heterogeneous-one or more of the servers or machines can operate according to one or more type of operating system platform.

Servers in the machine farm can be stored in high-density rack systems, along with associated storage systems, and located in an enterprise data center. For example, consolidating the servers in this way may improve system manageability, data security, the physical security of the system, and system performance by locating servers and high performance storage systems on localized high performance networks. Centralization of all or some of the data processing system 102 components, including servers and storage systems, and coupling them with advanced system management tools allows more efficient use of server resources, which saves power and processing requirements and reduces bandwidth usage.

The data processing system 102 can interface with, communicate with or otherwise access one or more location sensor devices 132. The location sensor device 132 can be associated with a vehicle 130. The location sensor device 132 can be located on the vehicle 130. The location sensor device 132 can be attached to the vehicle 130. The location sensor device 132 can be communicatively coupled or connected to the vehicle 130 via a communication port of the vehicle 130. The vehicle 130 can include one or more electronic connectors or ports. For example, the vehicle 130 can include an automotive auxiliary power outlet. The vehicle 130 can include an on-board diagnostic (“OBD”) port, such as an OBD-II port. An OBD-II can refer to or include an on-board computing that monitors emissions, mileage, speed, and other data associated with the vehicle 130. The OBD-II port can include a 16-pin port, for example. The vehicle 130 can include a J1939 connector, which can provide a high-layer protocol based on a controller area network. The J1939 connector can provide serial data communications between microprocessor systems.

The location sensor device 132 can include a location sensor, such as a global positioning system (“GPS”) sensor, cellular network triangulation device, wireless network-based location device, or other location device. In some cases, the location sensor device 132 can obtain location data from a location sensor built into the vehicle 130, in which case the location sensor device 132 can be referred to or include a data logger device.

The location sensor device 132 can be designed, constructed and operational to communicate with the data processing system 102 via the network 101. The location sensor device 132 can communicate location information or data logged from the vehicle 130 to the data processing system 102. The location sensor device 132 can receive instructions from the data processing system 102, receive request for information from the data processing system 102, or otherwise communicate with the data processing system 102. In some cases, the location sensor device 132 can be configured to run programs, scripts or routines provided by the data processing system 102 or otherwise established by an administrator or operator of the data processing system 102 or a farm.

The data processing system 102 can include, interface, or otherwise communicate with at least one data collector 104 (or data collector component). The data processing system 102 can include, interface, or otherwise communicate with at least one map generator 106 (or map generator component). The data processing system 102 can include, interface, or otherwise communicate with at least one row snapper 108 (or row snapper component). The data processing system 102 can include, interface, or otherwise communicate with at least one alert generator 110 (or alert generator component). The data processing system 102 can include, interface, or otherwise communicate with at least one data structure manager 112 (or data structure manager component). The data processing system 102 can include, interface, or otherwise communicate with at least one viewer 114 (or viewer component). The data processing system 102 can include, interface, or otherwise communicate with at least one data repository 126.

The data collector 104, map generator 106, row snapper 108, alert generator 110, data structure manager 112, and viewer 114 can each include at least one processing unit or other logic device such as programmable logic array engine, or module configured to communicate with the database repository 126 or database. The data collector 104, map generator 106, row snapper 108, alert generator 110, data structure manager 112, and viewer 114 can be separate components, a single component, or part of the data processing system 102. The system 100 and its components, such as a data processing system 102, can include hardware elements, such as one or more processors, logic devices, or circuits.

The data repository 126 can include one or more local or distributed databases, and can include a database management system. The data repository 126 can include computer data storage or memory and can store one or more of customer information 116, location data 118, tasks 120, maps 122, or logs 124. The customer information 116 can refer to or include information used to authenticate a user or determine which customer database to access to grab and process data. The customer information 116 can include the customer databases. The customer information 116 can include a list of tasks used to populate a drop down menu for a view, and contain information on which features are disabled or enabled for a particular customer. The customer information 116 can include a customer identifier, location, name of a farm, type of equipment associated with the customer, or other information.

The location data 118 can include location data points received from vehicles 130. The location data 118 can include historical location data points received from location sensor devices 132 and associated with a customer. The tasks 120 can include different types of task data structures. For example, the tasks 120 can include a trip task data structure. A trip task data structure can include metrics determined by the row snapper 108 and used by the viewer 114 to display via client device 134.

An example trip task data structure can include:

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
}
```

The tasks 120 data structure can include a task event. An example task event can include:

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
```

The maps 122 can include maps generated or received from client devices 134. The maps 122 can include maps generated by the map generator 106 to include rows for crops. The maps 122 can include shapefiles received from client devices 134. The logs 124 can include information associated with the vehicle 130, such as maintenance related information, engine status, oil status, fuel status, brake status, or other equipment status-related information.

The data processing system 102 can include an interface (or interface component) designed, configured, constructed, or operational to communicate with the client device 134 or location sensor device 132. The interface can receive and transmit information using one or more protocols, such as a network protocol. The interface can include a hardware interface, software interface, wired interface, or wireless interface. The interface can facilitate communication between one or more components of the data processing system 102. The interface can include or provide a user interface, such as a graphical user interface or frontend user interface. The interface can provide the user interface or access to a frontend interface via client device 134.

The data processing system 102 can include a data collector 104 designed, constructed, and operational to receive, collector, identify, or otherwise obtain data. The data collector 104 can obtain data from one or more device via network 101, including, for example, a location sensor device 132, data logger, client device 134, or a remote data source 136. The data collector 104 can receive data or information in any format, such as a hypertext markup language (“HTML”), comma-separated values (e.g., .CSV), an open extensible markup language (“XML”) spreadsheet (e.g., XLSX), images, vector-based maps, or a portable document format file (e.g., PDF).

The data collector 104 can receive data files comprising geospatial coordinates associated with a geographic area. The data collector 104 can receive the data file from an operator or manager of a farm via a client device 134. For example, the operator of the farm can generate, maintain or store the data file, and provide the data file to the data processing system 102. The geographic area can correspond to a farm. The data file can include or be a shapefile. A shapefile can refer to a nontopological format for storing the geometric location and attribute information of geographic features. Geographic features in a shapefile can be represented by points, lines, or polygons (e.g., areas). The shapefile format can include a geospatial vector data format for geographic information system (GIS) software. The shapefile format can spatially describe vector features: points, lines, and polygons, representing, for example, farm boundaries.

The data collector 104 can receive information from a remote data source 136. The remote data source 136 can include an online resource or other data resource. The remote data source 136 can include, for example, a map data repository or map service. The remote data source 136 can provide geographic information associated with satellite-based imagery or street-based mapping imagery.

The data collector 104 can receive data from location sensor device 132 or a data logger connected to the vehicle 130. The data collector 104 can receive location data points from the location sensor device 132. The data collector 104 can receive information corresponding to the vehicle 130, farm, or customer. For example, the location sensor device 132 can establish a communication session with the data processing system 102 or data collector 104 during which the location sensor device 132 can provide authentication credentials or other information that identifies the customer or farm. The data collector 104 can associate a username, user identifier, customer identifier, or other unique authenticating information with the location data points. The data collector 104 can store the received location data in the location data 118 repository. The data collector 104 can store other logged data received from the location sensor device 132 or data logger device in the data repository 126, such as in the logs 124 data structure.

The data collector 104 can store received data in the data repository 126 for future processing, or provide the received data to one or more component of the data processing system 102 for further processing or real-time processing.

The data processing system 102 can include a map generator 106 designed, constructed, and operational to receive a data file comprising geospatial coordinates for a geographic area. The map generator 106 can identify rows in the geographic area to associate with the geospatial coordinates. For example, a customer can provide the data processing system 102 with a shapefile highlighting field boundaries associated with the customer's farm. The shapefile can indicate blocks in the field that are within the boundaries. The map generator 106 can load the boundaries in a geographic information system (“GIS”) application that supports viewing, editing or analysis of the geospatial data. The map generator 106 can draw polylines for each row (e.g., in between the crops) per field. In some cases, a user can use the GIS application to draw the polylines. For example, the data processing system 102 can provide a graphical user interface for the GIS application to allow a user to provide input indicating polylines for rows in the shapefile. The rows can include or be referred to as polylines, in some implementations.

In some cases, the map generator 106 can be configured with machine learning or an image detection technique to automatically detect the rows and draw polylines. The map generator 106 can be configured with a model trained using machine learning and a training data set. The map generator 106 can include or be configured to perform one or machine learning technique. The map generator 106 can use any type of machine learning technique, including, for example, supervised learning, unsupervised learning, or reinforcement learning. The map generator 106 can use functions such as linear regression, logistic regression, a decision tree, support vector machine, Naïve Bayes, k-nearest neighbor, k-means, random forest, dimensionality reduction function, or gradient boosting functions.

The map generator 106 can use a training data set to train the model used to identify or detect rows in a shapefile. The training data can include the polylines for other shapefiles that were provided or indicated by customers or users. The training data can include manually identified rows. The map generator 106 can use the previously manually identified rows in shapefiles to train a model configured to automatically detect or predict rows in other shapefiles that were not previously received or processed by the data processing system 102.

The map generator 106 can store, in map data structure 122, the maps with the identified rows. The maps 122 can include geospatial coordinates corresponding to the polylines corresponding to the rows in between the crops in the shapefile. The map generator 106 can provide additional field metadata, such as the number of rows present in the field or farm, length of each row, or row spacing.

The data processing system 102 can include a row snapper 108 designed, constructed, and operational to determine whether location points received from the location sensor device 132 correspond to a particular row in the map generated by the map generator 106. For example, the data processing system 102 can receive a first location point from the location sensor device 132 as the vehicle 130 traverses a row in a field or on a farm. The row snapper 108 can determine, based on a comparison of the first location point and the geospatial coordinates associated with the row in the generated map, scores corresponding to a likelihood that the first location point is in each of the rows. The row snapper 108 can then identify the row with the highest score as the row that the vehicle 130 is most likely to be in, and then determine that the vehicle 130 is in the row.

The row snapper 108 can perform linear referencing to associate or snap a location data point received from the location sensor device 132 to a row in the map 122. Linear referencing can snap, assign, associate or move the location data point to a row in between crops identified in the shapefile for the farm. The row snapper 108 can determine which row a GPS point is closest to and “snapping” the GPS point to that row. Linear referencing can refer to or include, for example, storing geographic locations by using relative positions along a measured linear feature. Distance measures can be used to locate events along the line. Measurements along features can be used to locate point events and line events. For example, the locations of the event can be described in terms of measurements from a fixed point or known point, such as a point on or at a boundary of a region.

The row snapper 108 can use linear referencing to determine whether the GPS location point is in a particular block, and then determine which row in the block the location point is in along with a confidence value. By using linear referencing techniques, the row snapper 108 can determine which row the vehicle 130 is traveling on from receiving minimal or few data points, such as only two location data points (or GPS points) with a ±2 meter accuracy per row pass from the location sensor device 132. Thus, the row snapper 108 can reliably and accurately determine the row the vehicle 130 is traversing using noisy, low resolution, or minimal data points received from the location sensor device 132. To do so, the row snapper 108 can assume or take it as a given that when a vehicle 130 enters one end of the row, the vehicle 130 will exit the other end of the same row. Entering from one end of the row and exiting from the other end of the row can be referred to as a complete path or pass of the row. Thus, the row snapper 108, using linear referencing and being configured to assume the vehicle 130 enters one end and exits the other end of the row, can accurately and efficiently determine the vehicle 130 location or path within noisy, low resolution, or minimal location data points.

The row snapper 108 can generate scores, confidence scores, probability scores, or other values to determine whether a row is being covered based on the received GPS location points. The confidence score or probability score can indicate that a likelihood that the location point corresponds to a row or a likelihood that the vehicle 130 is traversing a row. The score can be based on one or more of: i) distance, duration, and angle between adjacent GPS points; ii) number of snaps to a particular row; or iii) positioning of the GPS points relative to the lengthwise direction of the rows (e.g., was the GPS point on the tip of the row and then mid-way or on the other end). For example, if the distance between adjacent points is low and the timestamps associated with the adjacent points is commensurate with the distance (e.g., based on an expected or average velocity of the vehicle 130), the data processing system 102 can assign a higher confidence score if the two location data points are snapped to the same row.

The row snapper 108 can establish or use confidence thresholds. As the data processing system receives location data points for a particular row, the data processing system can determine a confidence value for the particular row. The data processing system can assign a probability that the GPS location point is in each row. In some cases, the data processing system can apply a weight to generate a weighted score or probability for each data point for each row. The data processing system can perform this assessment for each path by bundling the data points for a particular path and processing the location data points for the path together.

The row snapper 108 can select confidence thresholds for the GPS points to determine which row the GPS point was most likely on based on the determined confidence scores. The thresholds can be predetermined or preset thresholds, or dynamically determined. The thresholds can be determined using trial and error and observing the output for false positives/negatives. In some cases, the row snapper 108 can use machine learning to automate the calibration of confidence scoring and thresholds, thereby improving accuracy of row coverage detection.

As the identified rows in the map 122 can include additional field metadata such as number of rows present, length of each row, row spacing, upon snapping GPS points to rows, the data processing system 102 can generate and display metrics indicating the operation on the field, such as: total acreage covered, percentage of field covered, or numbers of rows missed.

The row snapper 108 can snap a location data point (e.g., a GPS data point) to a row responsive to receipt of the location data point. The row snapper 108 can perform batch processing by receiving multiple location data points and then snapping the multiple location data points to one or more rows in a batch or bulk process. The row snapper 108 can wait until a certain number of location data points have been received before performing row snapping, or can wait a certain duration before performing row snapping. The row snapper 108 can wait for a condition or trigger event to perform row snapping, such as the triggering of a geofence associated with an end of a row or block or boundary of the field.

For example, the data processing system can receive multiple location points in a batch mode from the location sensor device 132 of the vehicle 130. The batch mode can correspond to a complete traversal of a row in the block or field. For example, the location sensor device 132 or the data processing system 102 can determine whether the vehicle 130 has completed the traversal of a row, and after the vehicle 130 has completed the traversal of a row, transmit the location points for that row to the data processing system 102. In some cases, the location sensor device 132 in communication with the data processing system 102 can determine the vehicle 130 completed traversing a row.

For example, and in some implementations, the location sensor device 132 can be configured to detect that the vehicle 130 has entered a first end of a row and exited a second end of the same row. The location sensor device 132 can be configured with or programmed with geofences that correspond to the ends of the rows. A geofence can refer to a virtual geographic boundary, defined by GPS or RFID technology, that allow the location sensor device 132 to trigger a response when the location sensor device 132 (or vehicle 130 thereof) enters or leaves a particular area. The data processing system 102 can provide the geofence configuration to the location sensor device 132 to cause the location sensor device 132 to detect that the vehicle 130 has entered a row and then exited a row. The location sensor device 132 can be further configured to transmit all the location data points collected by the location sensor device 132 as the vehicle 130 traversed the row (e.g., between the first geofence at the entry of the row and the second geofence at the exit of the row). The location sensor device 132 can package the location data points into a single data file or single transmission to the data processing system 102 via network 101, thereby transmitting the location points in a batch mode. By transmitting the location data points for a row in a batch mode, the location sensor device 132 can improve transmission efficiency by not streaming location data points in real-time, as well as network security by establishing a single secure communication as opposed to numerous communication sessions that may expose the location sensor device to 132 to greater opportunities for malicious attacks. Further, a batch transmission can reduce battery utilization of the location sensor device 132.

In some cases, the location sensor device 132 can be configured to transmit an indication to the data processing system 102 that the vehicle 130 has triggered a geofence. The data processing system 102, responsive to receiving the indication that the location sensor device 132 triggered geofence, can request the location sensor device 132 transmit all location data points that have not been transmitted to the data processing system 102.

The data processing system 102 can include an alert generator 110 designed, constructed, and operational to generate an alert or notification based on a performance of the vehicle 130. The alert can refer to an error, fault, failure, or other issue associated with the vehicle 130, or the performance of a task by the vehicle 130. The alert can refer to or include a notification, indication, signal, or prompt. The alert can include or refer to a preventative notification related to equipment maintenance or repair.

The alert generator 110 can generate the alert or notification to improve agricultural crop yield. The alert generator 110 can generate the alert to reduce waste or resource consumption, such as reduce fuel consumption, reduce battery consumption, reduce material use, or reduce chemical use. The alert generator 110 can generate alerts or notifications to improve efficiency of the agriculture production or vehicle 130 or other farm equipment performance.

For example, the alert generator 110 can generate an alarm in real-time. Generating an alarm in real-time can refer to the alert generator 110 determining which rows in a field the vehicle 130 has traversed using the row snapper 108, and then determining that the vehicle 130 has missed one or more rows or one or more blocks in the field. Missing a row can refer to the vehicle failing to traverse the row or failing to perform the desired task when traversing the row. For example, the task may be to spray a chemical on a crop, and the spray may have been turned off or when the vehicle traversed the row, thereby resulting in a mis-spray event. The alert generator 110 can detect the mis-spray event, and generate an alert responsive to detection of the mis-spray event.

To do so, the alert generator 110 can receive logs from the location sensor device 132 or other data logger device of the vehicle 130. The location sensor device 132 can include the data logger functionality or component. The data processing system 102, upon receiving the location data points, can snap the location data points to one or more rows of the map 122 generated by the map generator 106. The data processing system 102 can determine additional information associated with the location data points, such as whether the spray was turned on, what chemical was being sprayed, the duration of the spray, or the angle or direction in which the spray nozzle is pointed. Using the row snapped location data point and the task performance information, the alert generator 110 can determine which rows in the field the vehicle 130 traversed and what task is being performed by the vehicle 130 on that row.

If the alert generator 110 determines that the vehicle 130 traversed a first row, but did not turn on the spray, the alert generator 110 can generate an alert or alarm. In another example, the alert generator 110 can determine whether the vehicle 130 has previously sprayed a particular row within a time interval (e.g., in the last 24 hours or 48 hours or 72 hours), and if the vehicle 130 attempts to re-spray the same row within the time window, then generate an alert or alarm indicating that the vehicle 130 has already sprayed that row. In another example, the alert generator 110 can determine that the vehicle 130 missed spraying a block based on row snapped GPS points indicating that that the vehicle did not traverse any rows in the block.

For example, the data processing system 102 can determine, based on the location points corresponding to rows in the map 122, that the vehicle 130 traversed a first block in the geographic area associated with a first set of rows and did not traverse a second block in the geographic area associated with a second set of rows for which location points were not received. The data processing system 102 (e.g., via alert generator 110) can generate an alert indicating that the vehicle 130 failed to traverse the second block in the geographic area. The alert can include an audio or visual indication stating “warning missed row”. The alert can include a sound, haptic feedback, or visual notification.

The alert generator 110 can transmit the alert via network 101 or store the alert in the data repository 126, such as in customer info 116, tasks 120, or logs 124. The alert generator 110 can transmit the alert to one or more computing devices via network 101, such a client device 134. The client device 134 can be located with an operator or user of the vehicle 130, or administrator or operator of the farm. For example, the operator of the vehicle 130 can have access to a client device 134 (e.g., a tablet device or mobile device containing a display) that can communicate with the data processing system 102 via network 101. The data processing system 102 can transmit the alert to the client device 134 via a notification, text message, electronic message, or other format.

The data processing system 102 can include a data structure manager 112 designed, constructed, and operational to maintain, store, update, manipulate or other manage data structures that facilitate tracking performance of farm vehicles. The data structure manager 112 can update data structures stored in data repository 126. The data structure manager 112 can access and update one or more data structures or data bases based on information received from one or more component of the data processing system 102, or based on information or data values generated or updated by one or more components of the data processing system 102.

The data structure manager 112 can maintain a separate document for each particular vehicle, block, task, and day. The data structure manager 112 can maintain a separate document if any one of the vehicle, block, task or day is different. For example, there can a single document for each unique combination of vehicle identifier, block identifier, task identifier, and day. While this can result in a large number of documents in the data repository 126 (e.g., tasks 120), each document can be relatively smaller in file size and efficient to process or parse. Thus, by generating a large number of smaller documents, the data processing system 102 of this technical solution can facilitate efficient retrieval and parsing of task information.

An example task 120 data structure can include:

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
}
```

The above data structure can be referred to as a single document. This document can be for a particular vehicle, block, task, and day. As indicated above, this document relates to device: vehicle 1; block number: 2; task: spraying; and day Mar. 15, 2021. The data structure manager 112 can update the document with the rows that were covered by the vehicle. The rows_covered entry [1,0,0,1 . . . ] refers to the number of times the vehicle 1 traverses each row in the block. For example, the block can have 4 rows. The data structure manager 112 can generate an array with 4 columns or rows (e.g., a 1×4 array or a 4×1 array). The first entry in the array can correspond to the first row in the block, the second entry in the array can correspond to the second row, the third entry in the array can correspond to the third row, and the fourth entry in the array can correspond to the fourth row. The row snapper 108 can determine, based on received location points snapped to rows generated by the map generator 106, which rows the vehicle has traversed in the block. The data structure manager 112 can receive an indication of the traversed rows from the row snapper 108, and update the rows covered entry in the document accordingly. For example, if the vehicle 130 traversed each of the first row and the fourth row one time, then the rows covered array can be: [1,0,0,1]. The data processing system 102 can update the data structure in a batch mode or in real-time as new information is received or identified for the vehicle 130 or task.

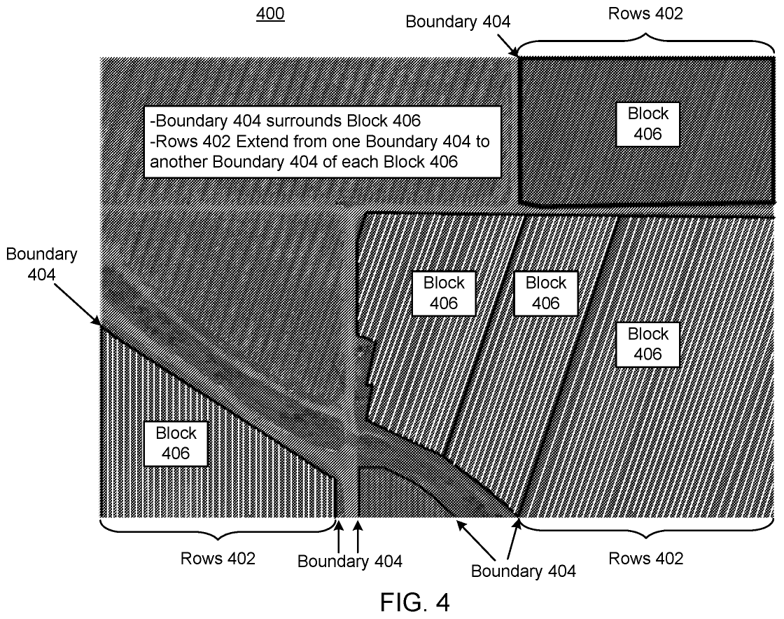

The data processing system 102 can include viewer 114 designed, constructed, and operational to provide one or more interactive user interfaces. The viewer 114 can generate an interactive graphical user interface for presentation via a client device 134. The client device 134 can interact with an interface provided or presented by the viewer 114. The viewer 114 can provide reports, notifications, alerts, alarms, dashboards, or other types of information via the interface. The viewer 114 can provide the interface via a web-based interface, mobile application interface, or electronic message, for example. The viewer 114 can update the interface responsive to an event or new data, such as in real-time. The viewer 114 can update the interface or information based on a time interval or in a batch mode, for example. The viewer 114 can update the interface responsive to a request from the client device 134 for updated or refreshed information. The viewer 114 can provide one or more interfaces, such as those depicted in FIGS. 4-13.

For example, the viewer 114 can provide an indication that the vehicle 130 traversed a row in the geographic area based on row snapping the GPS location point. The viewer 114 can update map with an indication that the vehicle 130 traversed the one or more rows of the field or block.

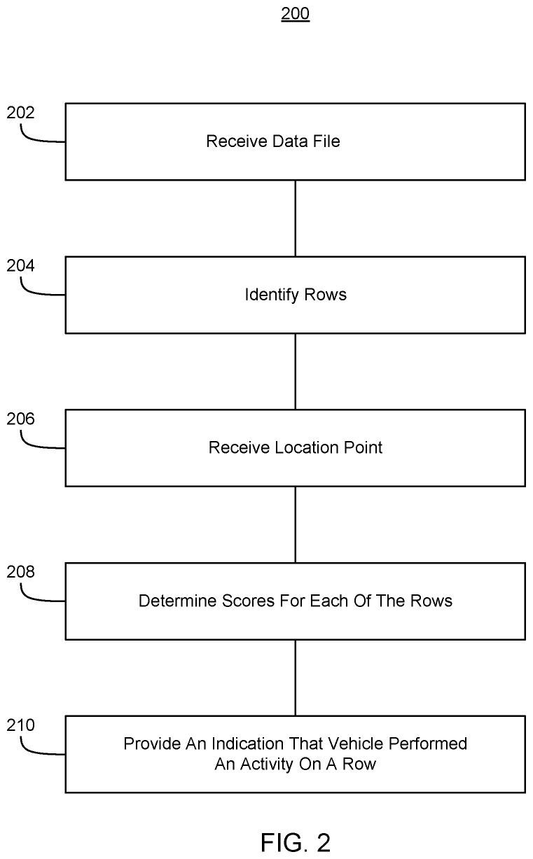

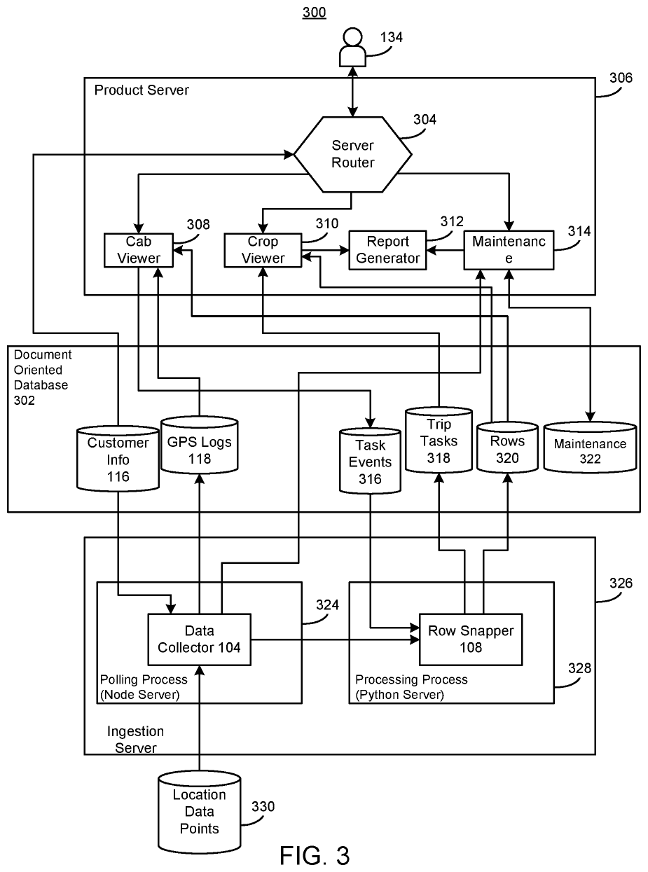

FIG. 2 is an illustration of an example method for tracking farm vehicle performance, in accordance with implementations. The method 200 can be performed by one or more system or component depicted in FIG. 1, FIG. 3 or FIG. 14, including, for example, a data processing system and location sensor device. At ACT 202, the data processing system can receive a data file. The data processing system can receive a data file with geospatial or geographic coordinates for a farm. The data file can be in any format, such as shapefile. The data processing system can receive the shapefile from a client computing device used by a farmer or other operator of a farm. The shapefile can include boundaries for the farm. The boundaries can be internal or external boundaries. The shapefile can include a perimeter boundary of the farm. The shapefile can include boundaries or blocks within the perimeter of the farm, for example. The data processing system can receive additional data associated with the farm. For example, the data processing system can query a satellite imagery database or a birds-eye image database for images of the geographic area corresponding to the shapefile.

At ACT 204, the data processing system can identify rows in the geographic area to associate the geospatial coordinates. To do so, the data processing system can use machine learning or image detection to identify the rows in the shapefile. The rows can correspond to the paths in between crops over which a vehicle drives or traverses the farm. The data processing system can provide a user interface to allow a user to mark or indicate the rows in the shape file.

At ACT 206, the data processing system can receive one or more location points. The data processing system can receive the location points from a device or sensor location on the vehicle or communicatively coupled to the vehicle. The data processing system can receive the location points via a network, such as a cellular network. The location points can include GPS location information, such as latitude and longitude coordinates. The location points can include a timestamp. Thus, the location data point can indicate a geographic location and timestamp of detection. The location data points can be collected or detected with a resolution. The resolution can be approximately 2 meters. The resolution can be greater than 2 meters or less than 2 meters. Even with poor resolution, the data processing system can use one or more row snapping techniques or linear referencing techniques to snap the location data point to a row, thereby determining accurate location information from noisy or low accuracy data.

At ACT 208, the data processing system can determine scores for each of the rows. The data processing system can receive the location data point and determine the likelihood that a particular location data points corresponds to each of the rows in the field. The data processing system can use linear referencing, along with factors such as characteristics between adjacent data points, number of snaps to a particular row, and positioning of a GPS point relative to a lengthwise direction of the row to determine the likelihood that a GPS point corresponds to a particular row. The data processing system can snap the location data point to the row associated with the highest confidence or likelihood.

At ACT 210, the data processing system can provide an indication to a client device that the vehicle performed an activity on at least a portion of a row. The activity can include, for example, traversing the row, moving along the row, spraying along the row, or other activity. The data processing system can receive an indication of the type of activity being performed by the vehicle, and provide an indication that the vehicle performed or facilitated the performance of the activity along at least a portion of the determined row. The data processing system can provide an indication that a vehicle may have skipped or missed traversal of a row. The data processing system can provide an indication that a task may or may not have been performed while the vehicle traversed the row, such as the vehicle did not spray the crops at the row, or the vehicle traversed the row twice and inadvertently sprayed the crops at that row twice within a time interval.

FIG. 3 is an illustration of an example system architecture for tracking farm vehicle performance, in accordance with implementations. The system 300 can include one or more component or functionality depicted FIG. 1 or FIG. 14. One or more component or functionality of system 300 can be provided along with or in conjunction with one or more component or function of system 100 depicted in FIG. 1.

The system 300 can include a product server 306 and an ingestion server 326. The product server 306 can provide a front-end to a client device 134, such as via a graphical user interface rendered by the client device 134 for display on a display device communicatively coupled to the client device 134. The product server 306 can include one or more component or functionality of viewer 114 depicted in FIG. 1. The viewer 114 can include the product server 306. The product server 306 can include one or more modules or components to provide user interfaces or information for presentation. For example, the product server 306 can include or execute a cab viewer component 308, a crop viewer component 310, a report generator component 312 and a maintenance component 314. The product server 306 can provide one or more of the graphical user interfaces depicted in FIGS. 4-13, for example. The cab viewer component 308, crop viewer component 310, report generator component 312 and maintenance component 314 can communicate with the client device 134 via a server router 304, which can include or interface with network 101.

The system 300 can include one or more databases, such as a document oriented database 302. In the document oriented database 302, each record can be stored as an object called a document. Documents can include fields and their associated values in a manner similar to a JSON object. The documents can belong to a specific collection, which groups similar documents together. Collections can belong to a specific database. For example, the database 302 can include a customer info collection 116, a GPS logs collection 118, a task events collection 316, a trip tasks collection 318, a rows collection 320, and a maintenance collection 322. The GPS logs collection 118 can include location data points from location sensor devices, as well as other logged data from a vehicle. The GPS logs collection 118 can include raw GPS points polled with date and time for each vehicle for the cab viewer 310 to plot.

The rows collection 320 can include coordinates used by the row snapper 108 to snap received location data points to a row. The cab viewer 308 and crop viewer 310 can use this information to plot rows covered. The rows collection 320 contains documents that are populated per block, per vehicle, per day. For example, a document in the rows collection 320 can include:

```
“data”: {
  “geometry”: {
    “type”: “LineString”,
    “coordinates”:[[lat, lon]]
    },
  “start_coord”: {
    “type”: “Point”,
    “coordinates”: [lat, lon]
    },
  “end_coord”: {
    “type”: “Point”,
    “coordinates”: [lat, lon]
    },
  “block_num”: 81,
  “device”: “vehicle 1”,
  “date_time”: Time(“2021-01-07T21:41:22Z”)
}
```

The metrics determined by rowSnap is contained in the TripTask collection for crop View to display to the user. Documents that are populated per block, per vehicle, per task, per day.

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
  }
```

The trip task collection 318 can include the metrics determined by the row snapper 108, which can be used by the crop viewer 310 to display via the client device 134. Documents in the trip tasks collection 318 can be populated per block, per vehicle, per task, per day as follows:

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
  }
```

The task event collection 316 can include documents generated with a log of the selected vehicle and task. The documents can be generated when the client device 134 logs into cab viewer 308. The row snapper 108 can incorporate the information in the task event collection 316 into the documents in the trip task collection 318. The documents in the task event collection 316 can include, for example:

```
“data”: {
  “task”: “spraying”,
  “start_time”: Time(2021-03-15 22:00:00),
  “duration”: 2.3,
  “end_time”: Time(2021-03-15 23:00:00),
  “device”: “vehicle 1”,
  “distance”: 2,
  “row_distance”: 4,
  “block_num”: 2,
  “rows_covered”: [1,0,0,1...]
  }
```

The maintenance collection 322 can include documents related to equipment faults, failure, duration of user, miles driven, tire pressure, oil pressure, fuel consumption, battery levels, or other information associated with vehicle equipment maintenance or repair.

The customer info collection 116 can be used to authenticate the client device 134 (or user thereof) as well as determine which customer database to access to grab and process data. The customer info collection 116 can include a list of tasks used to populate the drop down menu in cab viewer 308, and contains information on which features are disabled/enabled. A document in the customer info collection 116 can include:

```
{
  “ref”: Ref(Collection(“GeotabDatabases”), “297711537588535811”),
  “ts”: 1625253799050000,
  “data”: {
    “name”: “company_A”,
    “organizationName”: “Company_A”,
    “maintainerEmail”: “admin@companyA”,
    “enabled”: true,
    “maintenanceEnabled”: true,
    “cropviewEnabled”: true,
    “cabviewEnabled”: true,
    “rowsnapEnabled”: false,
    “taskMonitor”: {
      “enabled”: true,
      “list”: [
        “No Task”,
        “Task 1”,
        “Task 2”,
        “Spray-24”,
        “Spray-12”,
        “Pruning”
      ]
    },
    “timeZone”: “America/New_York”,
    “hour_off_set”: 0,
    “minute_off_set”: 0,
```

The product server 306 and ingestion server 326 can query the database 302 to obtain records or documents from one or more collections. The product server 306 and ingestion server 326 can update or store information in the database 302. The database 302 can include or refer to data repository 126 depicted in FIG. 1.

The system 300 can include an ingestion server 326 that can execute or provide a data collector 104 and row snapper 108. The data collector 104 can execute as part of a node server 324 that can provide a polling process. The data collector 104 can poll one or more location sensor devices 132. The data collector 104 can be configured to poll active or enabled location sensor devices 132 based on a time interval (e.g., every 1 minute, 2 minutes, 3 minutes, 4 minutes, 5 minutes, 10 minutes, 30 minutes, 1 hour, etc.). The data collector 104 can receive the location data points 330 from the location sensor devices responsive to the polling. In some cases, the location sensor devices can push location data points 330 to the data collector 104. The data collector 104 can provide the location data points to the row snapper 108 for processing.

The ingestion server 326 can include a python server 328 that executes the row snapper 108 to snap the location data points to rows. The ingestion server can provide the location data points and snapped row information to the database 302 for storage in a collection.

FIG. 4 is an illustration depicting identifying rows on a farm, in accordance with implementations. The map 400 with rows can be generated by one or more component or system depicted in FIG. 1, FIG. 3, or FIG. 14, including for example, a data processing system, or map generator. The data processing system can receive a data file or shapefile from a client device. The shapefile can include geospatial coordinates for the boundaries 404 that form each of the blocks 406. The data processing system can use the boundaries 404 as geofences. For example, the boundaries 404 can indicate an entry or exit for a row 402. The each end of a row 402 can be located at a boundary 404. Thus, the geospatial coordinates associated with a boundary 404 can be used to establish or configure a geofence. The data processing system or a location sensor device can use the geofence to trigger transmission location data points to the data processing system in a batch mode, for example. The data processing system can use the geofence corresponding to the boundaries 404 to determine the path or row the vehicle traverses.

The data file or shapefile received by the data processing system may not include an indication of the rows 402. The data processing system can identify or generate the rows 402 (e.g., a map generator). Each block 406 can have a boundary 404 with geospatial coordinates. The block 406 can include one or more rows 402. The rows can be in between crops. The data processing system can identify the rows using machine learning or image detection techniques. In some cases, a user can draw the rows 402 using a graphical user interface on the map 400.

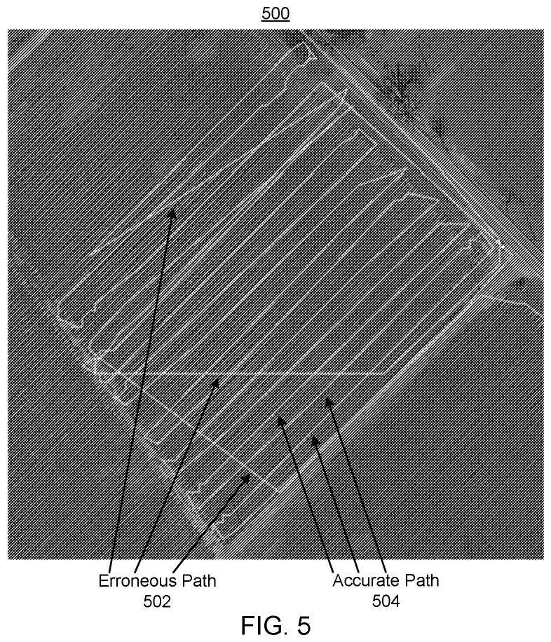

FIG. 5 is an illustration depicting a plot of location points received from a vehicle, in accordance with implementations. The map 500 can plotted or generated by one or more component or system depicted in FIG. 1, FIG. 3, or FIG. 14, including for example, a data processing system. The map 500 illustrates raw GPS point received from a location sensor device of a vehicle as the vehicle traverses the farm or rows. Plotting the raw GPS points illustrates erroneous paths 502, as well as accurate paths 504. Erroneous paths 502 can be plotted due to adjacent GPS points being connected in a manner that results in a path that is not physically possible for the vehicle to take or unlikely for the vehicle take. For example, it is unlikely that the vehicle would traverse the farm by cutting across multiple rows, as it would result in damage to the crops and the vehicle. Thus, path 502 can be deemed an erroneous path 502. It is, therefore, more likely that the vehicle would travel along the rows in the field, which are designed for the vehicle to travel along. However, due to missing location data points, or poor resolution location data points, the data processing system when plotting raw GPS points can generate erroneous paths 502. Thus, systems and methods of this technical solution can snap location data points to rows based on confidence scores in order to filter out or remove erroneous paths 502, while maintaining or identifying only accurate paths 504.

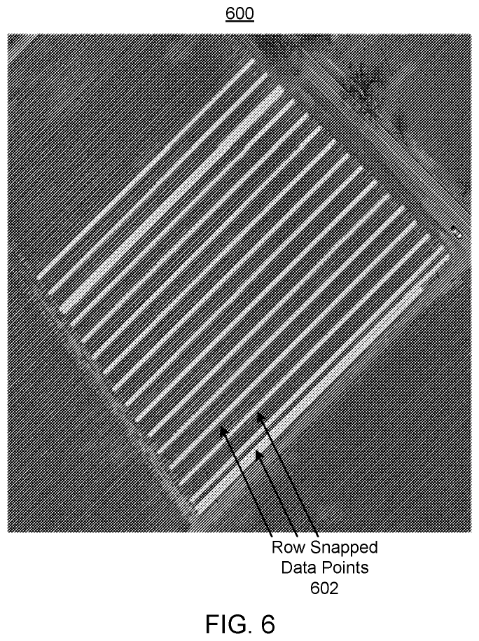

FIG. 6 is an illustration depicting a plot snapping the location points of FIG. 5 to the rows of FIG. 4, in accordance with implementations. The map 600 can plotted or generated by one or more component or system depicted in FIG. 1, FIG. 3, or FIG. 14, including for example, a data processing system. The data points 602 correspond to the row snapped raw GPS points from FIG. 5. As shown in map 600, the data processing system can snap the raw GPS points to rows using linear referencing and confidence scores to generate a map of the path the vehicle likely took to traverse the field, while removing or filtering out erroneous paths 504. As illustrated in map 600, the vehicle traversed the rows in a straight line from one boundary to another boundary in the field.

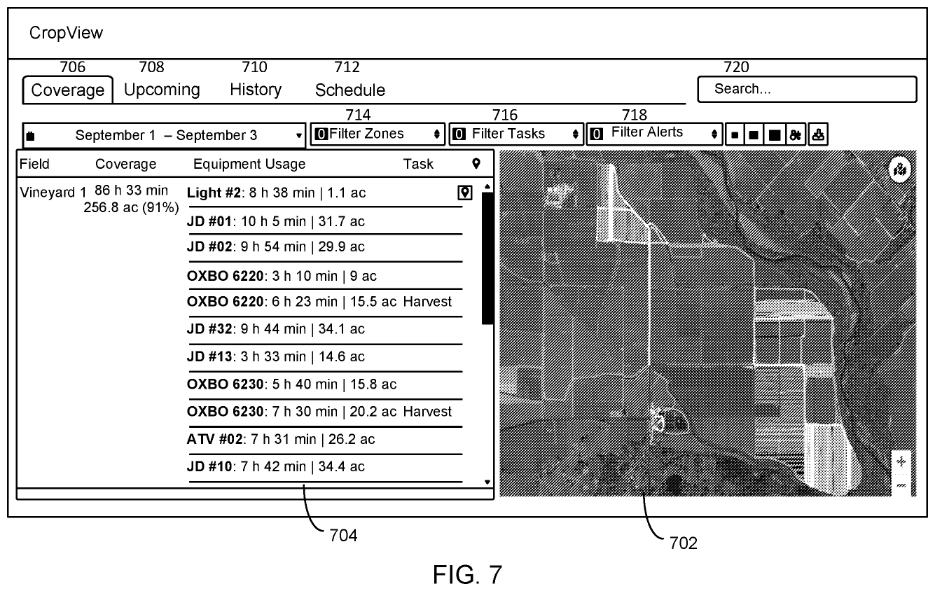

FIG. 7 is an illustration of a graphical user interface for interacting with row snapped data, in accordance with implementations. The graphical user interface 700 can be generated or provided via one or more system or component depicted in FIG. 1, FIG. 3, or FIG. 14, including, for example, a data processing system or viewer. The graphical user interface 700 illustrates the task performance of the vehicle as the vehicle traverses rows in the field. The GUI 700 indicates a map 702, and performance metrics or information 704, such as the block identifier, coverage (e.g., duration and amount or percentage of acreage covered in the block), equipment usage, and the task performed.

The GUI 700 can include or provide various views, including, for example, a coverage 706 view, upcoming tasks 708 view, historical tasks or actions 710 view, and a schedule 712. The GUI 700 can include a search 720 interface in which a user can enter a search query. The GUI 700 can include or allow for the selection or input of one or more filters. The data processing system 102 can filter tasks, actions, equipment, or other performance information based on or responsive to a filter. Filters can include, for example, filter zone 714, filter task 716, or filter alerts 718. For example, the cropview GUI 700 can provide information for certain zones based on the filter zones 714 dropdown menu. The GUI 700 can provide information for certain tasks based on or responsive to the filter tasks 716 dropdown menu. The GUI 700 can provide information for certain alerts based on or responsive to the filter alerts 718 dropdown menu 718.

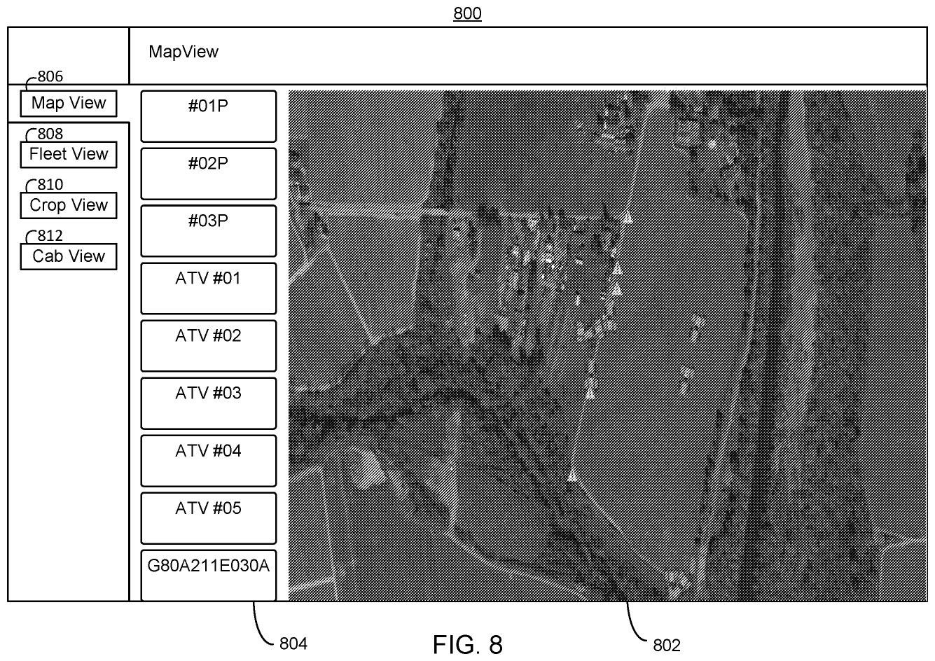

FIG. 8 is an illustration of tracking performance of one or more vehicles using the system of FIG. 1 or FIG. 3, in accordance with implementations. The graphical user interface 800 can be generated or provided by one or more system or component depicted in FIG. 1, FIG. 3, or FIG. 14, including for example a data processing system or a viewer. The GUI 800 can provide a map 802 and performance information 804, such as the vehicles that are performing tasks, the duration and the vehicle identifiers. The GUI 800 can provide additional views, such as a fleet view, crop view, or cab view. The GUI 800 can provide a map view 806, fleet view 808, crop view 810, or cab view 812. The data processing system 102 can receive a selection of one or more interactive GUI elements 806, 808, 810, or 812, and transition or switch the GUI to the corresponding selection. In some cases, the data processing system 102 can overlay the selected information on a portion 802 of the GUI 800.

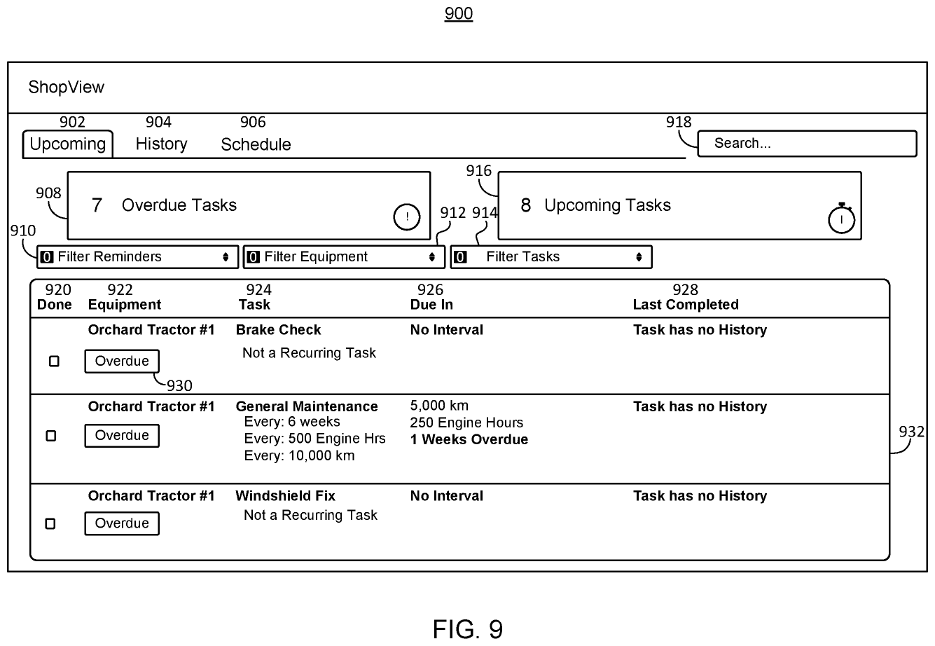

FIG. 9 is an illustration of tracking performance of one or more vehicles using the system of FIG. 1 or FIG. 3, in accordance with implementations. The graphical user interface 900 can be generated or provided by one or more system or component depicted in FIG. 1, FIG. 3, or FIG. 14, including for example a data processing system or a viewer. The GUI 900 can include service reminders, task status or statistics, or vehicle maintenance information.

The GUI 900 can include one or more views or toggle between one or more views, such as an upcoming 902 view, history 904 view, or a schedule 906 view. The GUI 900 can provide a search input 918 in which a user can input a search query for the data processing system 102 to execute. The GUI 900 can indicate an icon presenting a number of overdue tasks 908 and an icon presenting a number of upcoming tasks 916. The GUI 900 can indicate, provide, or include one or more filters. The filters can be presented as dropdown menus. The data processing system 102 can receive filter input via any other type of interactive UI element. For example, the filters can include a filter for reminders 910, a filter for equipment 912, and a filter for tasks 914. The GUI 900 can present, based on or responsive to filter input via one or more of filters 910, 912 or 914, information in a portion 932 of the GUI 900. The GUI portion 932 can indicate one or more tasks associated with one or more type of equipment, and information corresponding to one or more fields for the task. For example, the GUI portion 932 can indicate whether a task is done or not in field 920, the type of equipment in field 922, the task in field 924, when the task is due in field 926, whether the task is overdue 930, and when the task was last completed in field 928. In the example illustrated in FIG. 9, the three tasks include Brake Check, General Maintenance, and Windshield Fix. Each of the three tasks has a corresponding equipment field 922 (e.g., Orchard Tractor #1) due date field 926, a last completed field 928, and a field to indicate whether the task has been completed.

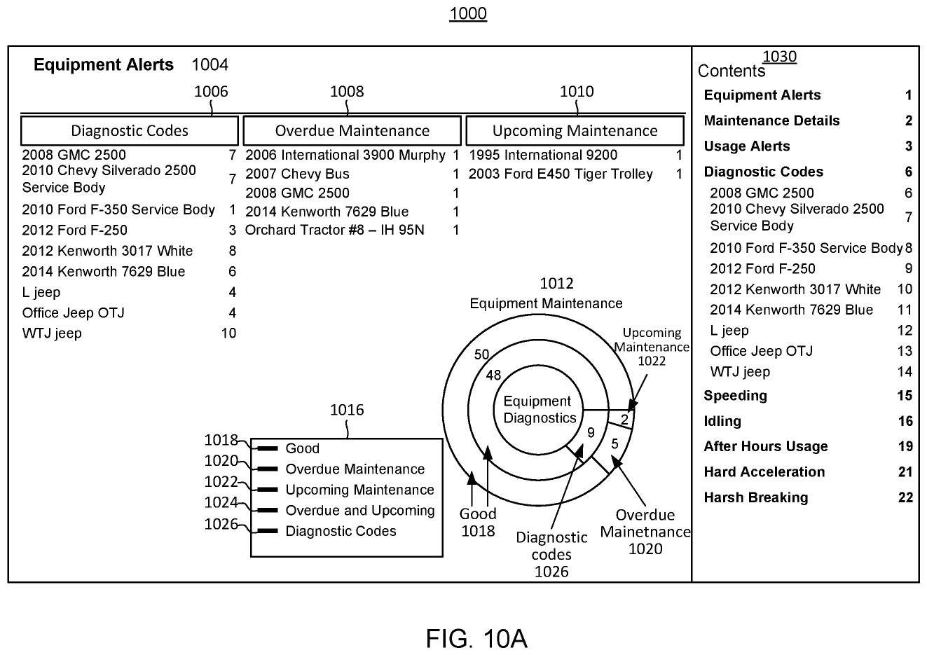

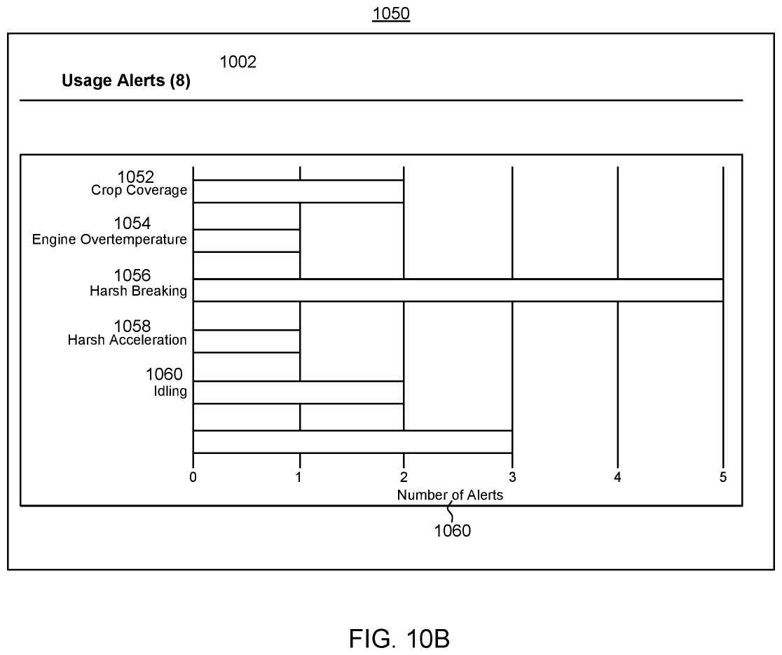

FIG. 10A is an illustration of providing alerts for one or more vehicles using the system of FIG. 1 or FIG. 3, in accordance with implementations. The graphical user interface 1000 can be generated or provided by one or more system or component depicted in FIG. 1, FIG. 3, or FIG. 14, including for example a data processing system or a viewer. The GUI 1000 can include equipment alerts 1004 categorized into diagnostic codes 1006, overdue maintenance 1008, and upcoming maintenance 1010. The GUI 1000 can provide contents 1030 that summarizes the information provided via GUI 1000.

The equipment alerts 1004 can be generated by an alert generator of the data processing system, for example. The alerts can improve vehicle or equipment performance, reduce failures, improve crop yield, or reduce resource consumption (e.g., energy, fuel, electricity, spray). The GUI 1000 can provide an equipment maintenance 1012 chart that indicates the number of pieces of equipment that have a status of Good 1018, the number of pieces of equipment that have diagnostic codes 1026, the number of pieces of equipment that have overdue maintenance 1020, and the number of pieces of equipment that have upcoming maintenance 1022. The legend in GUI 1000 can further indicate the number of pieces of equipment that are overdue and upcoming 1024.

FIG. 10B illustrates a GUI 1050 that can provide usage alerts 1002. The usage alerts 1002 can be generated by an alert generator of the data processing system, for example. The alerts can improve vehicle or equipment performance, reduce failures, improve crop yield, or reduce resource consumption (e.g., energy, fuel, electricity, spray). The GUI 1050 can indicate types of usage alerts, such as crop coverage alerts 1052, engine over temperature alerts 1054, harsh breaking alerts 1056, harsh acceleration 1058 alerts, and idling alerts 1060. The GUI 1050 can generate a histogram or frequency bar graph indicate a number of alerts in each category, with the x-axis indicate the number of alerts 1060.

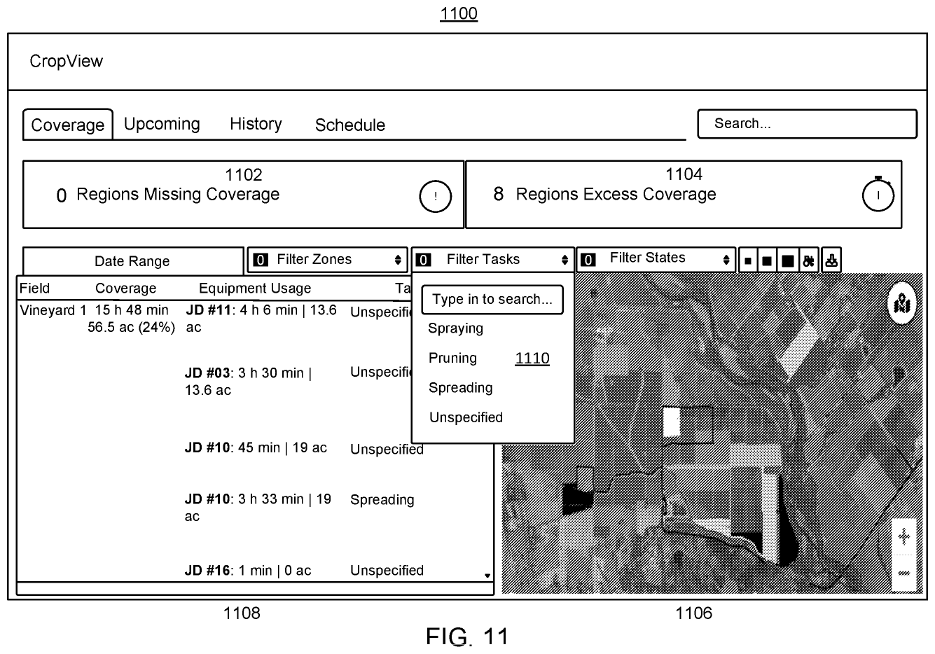

FIG. 11 is an illustration of tracking performance of one or more vehicles using the system of FIG. 1 or FIG. 3, in accordance with implementations. The graphical user interface 1100 can be generated or provided by one or more system or component depicted in FIG. 1, FIG. 3, or FIG. 14, including for example a data processing system or a viewer. The GUI 1100 can indicate the regions with missing coverage 1102, and the regions with excess coverage 1104, along with a map 1106 and vehicle performance metrics 1108. The GUI 1100 can provide a filter tasks interactive UI element 1110 in which a user can filter tasks using a drop down menu or can search for types of tasks by which to filter, such as spraying, pruning, spreading, or unspecified.

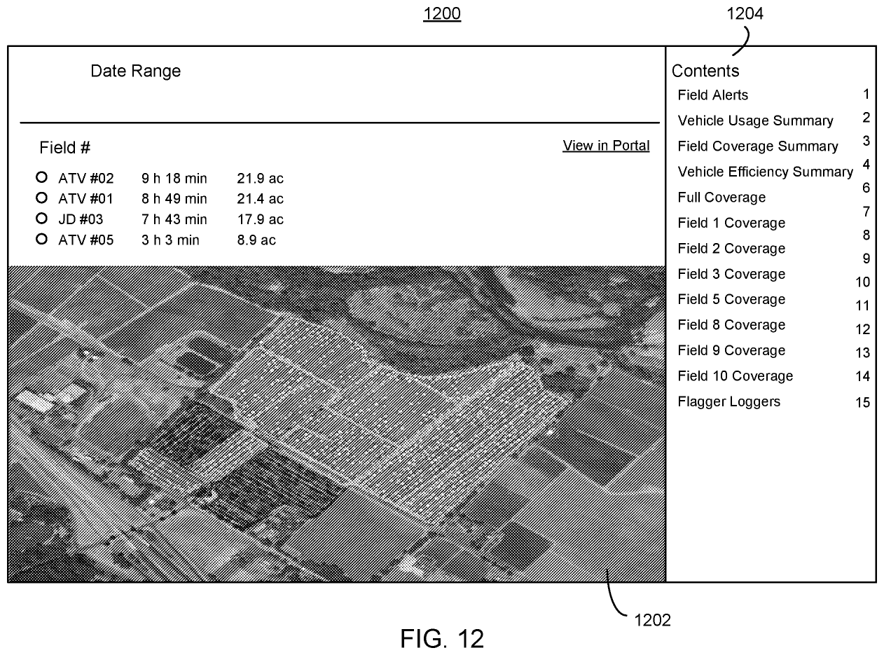

FIG. 12 is an illustration of tracking performance of one or more vehicles using the system of FIG. 1 or FIG. 3, in accordance with implementations. The graphical user interface 1200 can be generated or provided by one or more system or component depicted in FIG. 1, FIG. 3, or FIG. 14, including for example a data processing system or a viewer. The GUI 1200 can include one or more maps 1202 that indicate the performance or path associated with a vehicle. The GUI 1200 can indicate the performance for a particular field #. The GUI 1200 can include a table of contents 1204 via which the map 1202 can be interacted with in order to display performance of different fields, vehicles, alerts, or other information.

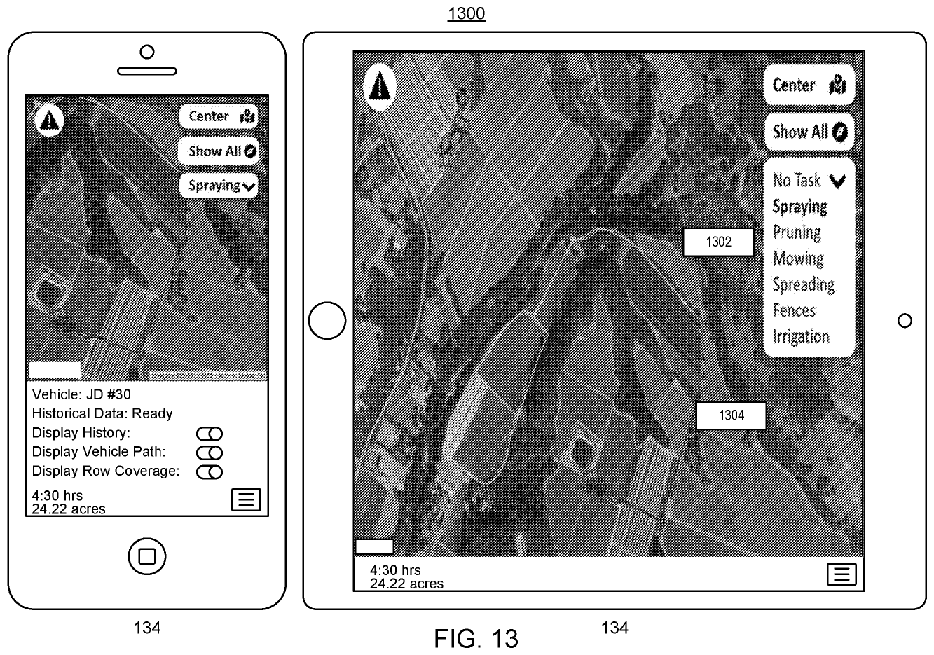

FIG. 13 is an illustration of tracking performance of one or more vehicles using the system of FIG. 1 or FIG. 3, in accordance with implementations. The graphical user interface 1300 can be generated or provided by one or more system or component depicted in FIG. 1, FIG. 3, or FIG. 14, including for example a data processing system or a viewer. A client device 134, such as a tablet device or mobile phone, can present the GUI 1300. The GUI 1300 can indicate the performance of the vehicle and the task performed by the vehicle. For example, the task 1302 can be spraying, pruning, mowing, spreading, fences, or irrigation. Selecting the task 1302 can reveal the path 1304 taken by the vehicle in performance of the task or where the vehicle has performed the task 1302.

FIG. 14 is a block diagram of an example computer system 1400. The computer system or computing device 1400 can include or be used to implement the systems 100 or 300 or their components such as the data processing system 102. The computing system 1400 includes a bus 1405 or other communication component for communicating information and a processor 1410 or processing circuit coupled to the bus 1405 for processing information. The computing system 1400 can also include one or more processors 1410 or processing circuits coupled to the bus for processing information. The computing system 1400 also includes main memory 1415, such as a random access memory (RAM) or other dynamic storage device, coupled to the bus 1405 for storing information, and instructions to be executed by the processor 1410. The main memory 1415 can be or include the data repository 126. The main memory 1415 can also be used for storing position information, temporary variables, or other intermediate information during execution of instructions by the processor 1410. The computing system 1400 may further include a read only memory (ROM) 1420 or other static storage device coupled to the bus 1405 for storing static information and instructions for the processor 1410. A storage device 1425, such as a solid state device, magnetic disk or optical disk, can be coupled to the bus 1405 to persistently store information and instructions. The storage device 1425 can include or be part of the data repository 126.

The computing system 1400 may be coupled via the bus 1405 to a display 1435, such as a liquid crystal display, or active matrix display, for displaying information to a user. An input device 1430, such as a keyboard including alphanumeric and other keys, may be coupled to the bus 1405 for communicating information and command selections to the processor 1410. The input device 1430 can include a touch screen display 1435. The input device 1430 can also include a cursor control, such as a mouse, a trackball, or cursor direction keys, for communicating direction information and command selections to the processor 1410 and for controlling cursor movement on the display 1435. The display 1435 can be part of the data processing system 102, the client device 134 or other component of FIG. 1, for example.

The processes, systems and methods described herein can be implemented by the computing system 1400 in response to the processor 1410 executing an arrangement of instructions contained in main memory 1415. Such instructions can be read into main memory 1415 from another computer-readable medium, such as the storage device 1425. Execution of the arrangement of instructions contained in main memory 1415 causes the computing system 1400 to perform the illustrative processes described herein. One or more processors in a multi-processing arrangement may also be employed to execute the instructions contained in main memory 1415. Hard-wired circuitry can be used in place of or in combination with software instructions together with the systems and methods described herein. Systems and methods described herein are not limited to any specific combination of hardware circuitry and software.

Although an example computing system has been described in FIG. 14, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. For example, data collector 104, map generator 106, row snapper 108, alert generator 110, and other data processing system 102 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 1400 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of the user interaction) can be received from the client device at the server (e.g., received by the data processing system 102 from the client device 134 or the remote data source 136).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the data collector 104 and row snapper 108 can be a single component, app, or program, or a logic device having one or more processing circuits, or part of one or more servers of the data processing system 102.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system to track farm vehicle performance, comprising:
a data processing system comprising one or more processors coupled with memory to:
receive a data file comprising geospatial coordinates for a geographic area;
identify a plurality of rows in the geographic area to associate with the geospatial coordinates;
receive, from a sensor of a vehicle located in the geographic area, a first location point;
determine, based on a comparison of the first location point and the geospatial coordinates associated with the plurality of rows, a plurality of scores corresponding to a likelihood that the first location point is in each of the plurality of rows; and
provide an indication that the vehicle performed an activity on at least a portion of a first row of the plurality of rows in the geographic area based on the plurality of scores.

2. The system of claim 1, wherein the data file comprises boundaries for a field comprising the geographic area, and the plurality of rows are in-between crops located on the field.

3. The system of claim 1, comprising:
the data processing system to receive a plurality of location points in a batch mode from the sensor of the vehicle, wherein the batch mode corresponds to a complete traversal of a row of the plurality of rows.

4. The system of claim 3, comprising:
a local computing device of the vehicle to:
detect completion of traversal of the row based on triggering a first geofence at a first end of the row and triggering a second geofence at a second end of the row opposite the first end; and
transmit, to the data processing system, the plurality of location points in the batch mode responsive to detection of the completion of the traversal of the row.

5. The system of claim 1, comprising the data processing system to:
receive a second location point subsequent to receipt of the first location point;
determine the second location point corresponds to a fourth row of the plurality of rows, the fourth row separated from the first row by a second row of the plurality of rows and a third row of the plurality of rows; and
determine, based on the first location point and the second location point, that the vehicle traversed the second row and the third row.

6. The system of claim 5, comprising the data processing system to:
determine that the data processing system did not receive location data points corresponding to the second row and the third row.

7. The system of claim 1, comprising the data processing system to:
receive a plurality of location points via the sensor of the vehicle;
determine, based on the plurality of location points corresponding to a first plurality of rows in the plurality of rows, that the vehicle traversed a first block in the geographic area associated with the first plurality of rows and did not traverse a second block in the geographic area associated with a second plurality of rows of the plurality of rows for which location points were not received; and
generate an alert indicating that the vehicle failed to traverse the second block in the geographic area.

8. The system of claim 1, comprising:
the data processing system to provide, via a network, the indication via a display coupled to a computing device.

9. The system of claim 1, comprising:
the data processing system to update a data structure for the vehicle with the indication that the vehicle traversed the first row, the data structure including a task, a date, and a start time.

10. The system of claim 1, comprising:
the data processing system to use machine learning or image detection to identify the plurality of rows based on the data file for the geographic area.

11. The system of claim 1, comprising:
the data processing system to determine the plurality of scores based on at least one of a distance between adjacent location points, a duration between adjacent location points, or an angle between adjacent location points.

12. A method of tracking farm vehicle performance, comprising:
receiving, by a data processing system, a data file comprising geospatial coordinates for a geographic area;
identifying, by the data processing system, a plurality of rows in the geographic area to associate with the geospatial coordinates;
receiving, by the data processing system, from a sensor of a vehicle located in the geographic area, a first location point;
determining, by the data processing system, based on a comparison of the first location point and the geospatial coordinates associated with the plurality of rows, a plurality of scores corresponding to a likelihood that the first location point is in each of the plurality of rows; and
providing, by the data processing system, an indication that the vehicle performed an activity on at least a portion of a first row of the plurality of rows in the geographic area based on the plurality of scores.

13. The method of claim 12, wherein the data file comprises boundaries for a field comprising the geographic area, and the plurality of rows are in-between crops located on the field.

14. The method of claim 12, comprising:
receiving, by the data processing system, a plurality of location points in a batch mode from the sensor of the vehicle, wherein the batch mode corresponds to a complete traversal of a row of the plurality of rows.

15. The method of claim 14, comprising:
detecting, by a location sensor device of the vehicle, completion of traversal of the row based on triggering a first geofence at a first end of the row and triggering a second geofence at a second end of the row opposite the first end; and
transmitting, by the location sensor device, to the data processing system, the plurality of location points in the batch mode responsive to detection of the completion of the traversal of the row.

16. The method of claim 12, comprising:
receiving, by the data processing system, a second location point subsequent to receipt of the first location point;
determining, by the data processing system, the second location point corresponds to a fourth row of the plurality of rows, the fourth row separated from the first row by a second row of the plurality of rows and a third row of the plurality of rows; and
determining, by the data processing system, based on the first location point and the second location point, that the vehicle traversed the second row and the third row.

17. The method of claim 16, comprising:
determining, by the data processing system, that the data processing system did not receive location data points corresponding to the second row and the third row.

18. The method of claim 12, comprising:
receiving, by the data processing system, a plurality of location points via the sensor of the vehicle;
determining, by the data processing system based on the plurality of location points corresponding to a first plurality of rows in the plurality of rows, that the vehicle traversed a first block in the geographic area associated with the first plurality of rows and did not traverse a second block in the geographic area associated with a second plurality of rows of the plurality of rows for which location points were not received; and
generating, by the data processing system, an alert indicating that the vehicle failed to traverse the second block in the geographic area.

19. The method of claim 12, comprising:
providing, by the data processing system via a network, the indication via a display coupled to a computing device.

20. The method of claim 12, comprising:
updating, by the data processing system, a data structure for the vehicle with the indication that the vehicle performed the activity on the at least the portion of the first row, the data structure including a task, a date, and a start time.
